(19) United States
(12) Patent Application Publication
(10) Pub. No.: US 2025/0129986 A1
(43) Pub. Date: Apr. 24, 2025

(54) PARTICLE-DRYING APPARATUS WITH RECYCLING OF A PORTION OF THE HOT GAS

(71) Applicant: Leon Crosset, Thimister (BE)

(72) Inventor: Leon Crosset, Thimister (BE)

(21) Appl. No.: 18/729,277

(22) PCT Filed: Jan. 31, 2023
(86) PCT No.: PCT/EP2023/052348

§ 371 Date: Jul. 16, 2024

(30) Foreign Application Priority Data
Feb. 14, 2022 (BE) BE2022/5095

(51) Int. Cl. F26B 17/00; F26B 21/02; F26B 21/12

(52) U.S. Cl. CPC F26B 17/005; F26B 21/02; F26B 21/12; F26B 2200/24

(57) ABSTRACT

A dryer (1) for drying particles is provided that includes an enclosure, a circular tray mounted in the enclosure, the surface of which is perforated and permeable to gases, a distribution system and a recovery system for particles. The dryer also includes a hot-gas blowing system with N fans designed to generate a flow of hot gas along N gas columns, each gas column i passing through a different angular section (1.i) of the tray. Having passed through the (N−1) first angular sections of the tray, the (N−1) first gas columns are extracted from the enclosure or recirculated after drying and heating. Having passed through the Nth angular section (1.N) of the tray, the hot gas of the Nth gas column is recirculated by the Nth fan (5N) to form the first gas column (1.1) passing through the first angular sector (1.1) of the tray.

### DOMAIN OF THE INVENTION

The invention relates to an industrial dryer for continuously drying particles, preferably organic particles, for example of agri-food origin, such as cereals, or waste used as fuel or construction materials, such as chips or fibers of wood or other plant matter.

### TECHNICAL BACKGROUND

Numerous industrial processes require particles to be dried before subsequent use, whether this is before packaging of granular agri-food products or industrial products, or before combustion of ground waste used as fuel. Depending on the anticipated use, the particles must be dried to reach final moisture contents within well-defined target ranges (H1t±ε). For example, wood chips must be dried to target ranges that differ depending on whether they are intended for combustion, pellet production, bedding production, or fiberboard production. It is naturally possible to dry particles in batches by depositing the particles on trays that are preferably perforated to enable a hot gas to pass through and to enable the water and steam to be discharged. In some cases, a fluidized bed is formed by the particles in suspension under the action of the flow of hot gas. However, most industrial applications require throughput rates that a batch drying process cannot achieve. For this reason, the same principle of depositing the particles to be dried on a perforated support and exposing them to a flow of hot gas has been applied to equipment enabling continuous drying, with a continuous source of particles to be dried upstream of the dryer itself and a continuous discharge of dry particles downstream thereof.

In particular, a belt dryer comprises a continuous flexible perforated belt stretched between two motorized rollers forming a loop. Air or another hot gas is blown under the top canvas on which the particles to be dried are deposited continuously. The length of a belt dryer depends on the type of particles to be dried, the water content thereof, and the target water content range (H1t±ε) to be achieved. A belt may therefore be as much as 200 meters long, which is very expensive and difficult to assemble/disassemble on the equipment. A belt dryer is therefore usually only used to dry a single particle type, since it would not be economical to change the belt to optimize the perforation type for a new particle type. Belt dryers are very costly and relatively inefficient in terms of dimensions, since the particles are only dried over less than one half of the length of the belt.

There are also perforated-tray dryers, which are similar to belt dryers, except that the belt is replaced by perforated trays coupled to one another to form a sort of caterpillar track. The difference from a belt dryer is that the trays are articulated such as to present the same face on the top and bottom belt of the loop. In practice, this halves the length of the dryer, since the particles are subjected to the flow of hot gas twice: a first time as they pass along the top portion of the loop and a second time as they pass in the opposite direction along the bottom portion. Although this is advantageous in this respect compared to a belt dryer, it is clear that the mechanics required to move the trays is complicated and therefore costly and fragile, in particular when exposed to fine particles that can cause the bearings to seize. Furthermore, every opening created between two adjacent trays, and in particular every gap opening in the tray transfer mechanism as the trays are transferred from the top portion to the bottom portion of the caterpillar track, creates many preferred passages of less resistance for the flow of hot gas, which causes a significant loss in efficiency in this type of dryer.

EP0197171 describes a dryer comprising several perforated, circular, superposed trays mounted in rotation on a hollow central shaft. Each tray is enclosed in an individual cylindrical chamber provided with a ceiling and a floor separating it from the other trays. Means for transferring the powder to be dried are provided between each adjacent tray. Each chamber is provided, on one hand, with a first hot-air injection opening in fluidic communication with the cavity in the hollow central shaft, the first opening being positioned above the tray in the corresponding chamber, and, on the other hand, with a second discharge opening in the peripheral wall of the chamber in communication with the outside, the second opening being below the corresponding tray. Hot air is blown into the cavity in the hollow shaft and is distributed in parallel to each chamber by the first hot-air injection opening. The hot air is forced to pass through the circular perforated tray before being discharged through the second opening in the peripheral wall of each chamber. In reality, such a system is similar in principle to a belt dryer in which the linear movement has been replaced by a circular movement spread over several levels with means for transferring the powder from one tray to another. Such a rotary system does of course have the considerable advantage of saving floorspace compared to a linear belt dryer, but such a system lacks efficiency. This is because, if the hot air that has passed through the first trays filled with very moist particles comes out relatively saturated with moisture, the hot air passing through the last trays filled with particles already partially dried on the preceding trays comes out without absorbing much moisture, which represents a considerable waste of energy.

EP2828595 describes a dryer illustrated in FIG. 1 comprising first and second (or more) superposed perforated trays (1a, 1b) mounted in rotation about a vertical axis (Z). A ventilation system blows a hot gas vertically first through the second tray (1b) and then directly through the first tray (1a). Being a dryer, the hot gas, after it has passed through the second tray (1b) then the first tray (1a) is either discharged or recirculated, but such recirculation is conditioned by the drying and reheating of the air to be recirculated before it is reinjected through the second tray.

The moist particles are distributed along a radius of the first tray (1a) by a first distribution unit (2a) and carried by the rotation of the first tray over an angular distance (or azimuth) of just under 360° before being collected by a first recovery unit (3a). As the first tray (1a) rotates, the particles are exposed to the current of hot gas that has previously passed through the second tray, where it lost some of its heat energy and absorbed some moisture. The partially dried particles are transferred by a transfer unit (4t) of the first recovery unit to a second distribution (2b) system (3a) that distributes the partially dried particles along a radius of the second tray (1b), which rotates about the vertical axis (Z) in the opposite direction to the first tray (1a). The partially dried particles are carried by the rotation of the second tray (1b) (in the opposite direction to the first tray) over an angular distance (or azimuth) of just under 360° before being collected by a second recovery unit (3b) and discharged. As the second tray (1b) rotates, the particles are exposed to the current of hot gas directly from the ventilation system, where the hot gas is at maximum temperature and minimum moisture content.

As shown in FIG. 1, as the trays turn in opposite directions, the hot gas reaching the particles that have just been deposited along the radius of the first tray, where the moisture content thereof is highest (H0a/H0a=100%), has the highest temperature and lowest moisture content of all of the hot gas reaching the first tray, since it has previously passed through the practically dry particles (final moisture content H1b) just before being discharged with a moisture content that may be in the order of (by way of example) H1b/H0a=12%, where H0a is the initial moisture content of the particles entering the first tray (1a) and H1b is the final moisture content of the particles leaving the second tray (1b).

The dryer described in EP2828595 is particularly efficient in terms of energy, usage, floorspace occupation, and throughput. The throughput of particles to be dried in a dryer can be optimized by modifying the dimensions of the trays and of the enclosure. For high throughput rates, the radius of the trays can be increased. For very high throughput rates, a third tray is also described in EP2828595. However, for more modest throughput rates, the corresponding reduction in the size of the trays is not compensated by a corresponding reduction in the production cost of the dryer, since at least two trays, as well as two sets of distribution and recovery units, and one distribution unit, the prices of which cannot be reduced, are required regardless of the size of the trays.

There is therefore still a need for an industrial dryer for continuously drying particles at throughput rates more modest than those provided by the dry described in EP2828595, and that is efficient and less costly to produce.

### SUMMARY OF THE INVENTION

The present invention is defined in the independent claims. Preferred variants are defined in the independent claims. In particular, the present invention relates to a dryer for drying particles comprising:
(a) an enclosure comprising an essentially cylindrical wall extending along a vertical axis (Z),
(b) a single tray that is circular and mounted in the enclosure, substantially normal to the vertical axis (Z), in rotation in a direction of rotation about the vertical axis (Z), the surface of the tray being perforated and permeable to gases such as air and steam and water,
(c) a distribution system that is designed to distribute the particles before drying along a radius of the tray,
(d) a recovery system that is designed to collect the particles deposited on the tray after a rotation of the tray through an angle formed between the distribution system and the recovery system, the recovery system being located downstream of and preferably adjacent to the distribution system.

The dryer further comprises a hot-gas blowing system comprising N fans designed to generate flows of hot gas along N gas columns that are substantially parallel to the vertical axis (Z), each gas column passing through a different angular section of the tray, with N∈N and N>1, wherein
(a) the N angular sections of the tray cover the whole of an area of the tray between the distribution system and the recovery system,
(b) a first fan designed to generate a flow of hot gas along a first gas column is positioned downstream of the distribution system, the first gas column passing through a first angular section of the tray adjacent to or containing the distribution system,
(c) an Nth fan designed to generate a flow of hot gas along an N^{th} gas column is positioned upstream of the recovery system, the N^{th} gas column passing through an N^{th} angular section of the tray adjacent to or including the recovery system, wherein the terms “upstream” and “downstream” refer to the direction of rotation of the tray, and
(d) second to (N−1)^{th} fans are distributed angularly about the vertical axis (Z) between the first and N^{th} fans, which are designed to generate flows of hot gas along second to (N−1)^{th} gas columns passing through second to (N−1)^{th} angular sectors including between the first and N^{th} angular sectors,
(e) having passed through the first to the (N−1)^{th} angular sections of the tray, the first to the (N−1)^{th} gas columns are either extracted from the enclosure or the gas in these columns is dried and reheated before being recirculated by the second to the N^{th} fans to pass through the second to the N^{th} angular sections of the tray in another cycle.

The present invention differs from the dryers in the prior art in that having passed through the N^{th} angular section of the single tray, the hot gas of the N^{th} gas column is recirculated to form, on its own or combined with an additional hot gas, the first gas column passing through the first angular sector of the single tray.

In one embodiment, the tray single comprises a chimney that is centered on the vertical axis (Z) and passes through the tray via a circular opening with an internal radius less than the radius of the tray. The fans may then be disposed inside the chimney and may each be associated with a vertical deflection system designed to guide the hot gas generated by each fan into the enclosure and out of the chimney and to orient it substantially parallel to the vertical axis (Z) toward the corresponding angular sectors, thereby forming corresponding gas columns. The vertical deflection system may preferably comprise at least one of the following: a tube, a deflection surface or a network of deflection surfaces, which is coupled to at least one opening in a wall of the chimney.

Preferably, the dryer also comprises a recirculation deflection system designed to recirculate the gas from the N^{th} column toward the first fan by guiding it toward the inside of the chimney. The recirculation deflection system preferably comprises one or more of the following: a tube, a deflection surface or a network of deflection surfaces, a fan, which is coupled to at least one opening in a wall of the chimney.

The dryer may further comprise a controller designed to control one or more of the following parameters:
a gas flow rate from one or more of the N fans,
a proportion of the first gas column that is gas recycled from the N^{th} column toward the first fan,
a geometry of the vertical deflection system that modifies an extent of each angular sector and a degree of overlap between two adjacent angular sectors.

The dryer preferably also comprises a temperature sensor and a moisture sensor designed to measure the temperature and the moisture content of the hot gas coming out of the N^{th} angular section before being recirculated toward the first gas column, and wherein the controller is designed to determine the proportion of the first gas column that is gas recycled from the N^{th} column toward the first fan on the basis of the temperature and moisture content values measured by the temperature and moisture sensors.

The hot-gas blowing system preferably comprises:
a fan, preferably N fans located upstream of the single tray and designed to blow the hot gas, preferably hot air, and
a gas heating device designed to heat the hot gas thus blown upstream of the single tray,
   where the term “upstream” refers to the direction of the flow of hot gas.

The hot-gas blowing system may also or alternatively comprise:
a fan, preferably N fans located downstream of the single tray and designed to aspirate the hot gas, preferably hot air, and
a gas heating device designed to heat the hot gas thus aspirated, located upstream of the single tray, wherein the gas heating device comprises at least one of the following: a heat exchanger or a gas burner,
   where the terms “upstream” and “downstream” refer to the direction of the flow of hot gas.

The hot gas may circulate from the top downwards, or alternatively the hot gas may circulate from the bottom upwards. The hot gas is preferably hot air.

The tray may further comprise a highly permeable, rigid, self-supporting grating structure, on which is placed a filtering layer comprising openings of size and density corresponding to the desired permeability depending on the type and size of particles to be dried.

The system for distributing the particles to be dried on the tray may comprise at least one Archimedes screw extending along a radius of the tray, said at least one Archimedes screw being enclosed in an enclosure provided with one or more openings extending along said radius of the tray.

The recovery system of the tray may comprise at least one Archimedes screw extending along a radius of said tray that is enclosed in an enclosure provided with one or more openings extending along said radius of the tray, said openings being connected to a scraper or brush designed to collect and guide the particles conveyed by the rotation of the tray toward the Archimedes screw.

The dryer advantageously comprises a static floor located beneath the tray along the vertical axis Z, the floor comprising an opening for discharging the finest particles deposited on the floor. The dryer may further comprise a scraper rigidly connected to the tray and designed to follow the rotational movement thereof to push the particles deposited on the floor toward said discharge opening.

The particles to be dried may preferably comprise wood waste from sawmills, wood waste from construction materials, paper or cardboard waste, agri-food products and are in the form of powder, granules, chips, pellets, meals, or pieces not usually greater than 10 cm long.

### SHORT DESCRIPTION OF THE FIGURES

To better understand the nature of the present invention, reference should be made to the following figures, in which:

FIG. 1 shows a disc dryer from the prior art, as described in EP197171,

FIG. 2 shows a dryer according to the present invention,

FIG. 3 shows a variant of the dryer according to the present invention,

FIG. 4 is a top view of the dryer according to the present invention,

FIG. 5 illustrates the recirculation of the hot gas in a dryer according to the present invention,

FIGS. 6(a) & 6(b) show an example distribution system adapted to the present invention, (a) perspective view, (b) top view,

FIGS. 7(a) & 7(b) show an example recovery system adapted to the present invention, (a) top view, (b) cross section,

FIGS. 7(c) & 7(d) show another example recovery system adapted to the present invention, (c) top view, (d) cross section,

FIG. 8(a) shows the tray (1) comprising a self-supporting rigid structure (1) comprising the openings of given diameter,

FIG. 8(b) shows the tray (1) comprising a highly permeable, rigid, self-supporting grating structure (1c) covered with a removable flexible layer (1p) comprising openings of the desired diameter depending on the application.

### DETAILED DESCRIPTION

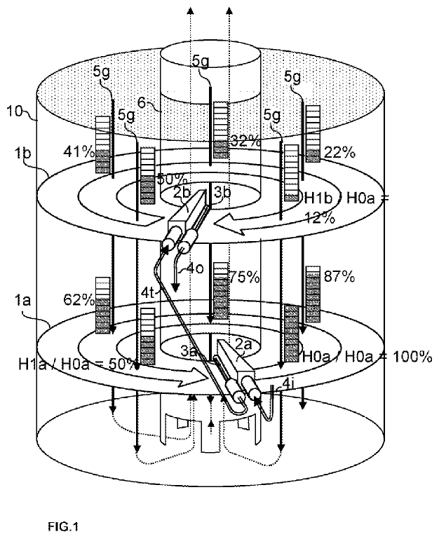

The dryer according to the present invention is preferably a variation of a dryer of the type described in EP2828595, which is discussed in the “technical background” section above and illustrated in FIG. 1 with the superposed two trays (1a, 1b) thereof rotating in opposite directions. However, the dryer according to the present invention is adapted to more modest throughput rates for the particles to be dried than the dryer described in EP2828595, and has only one tray (1).

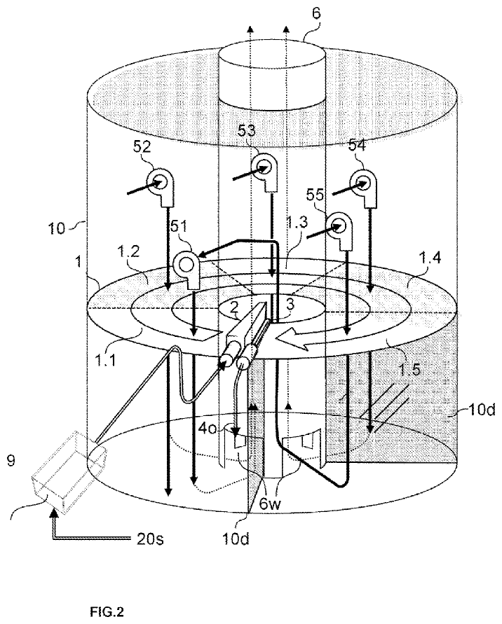

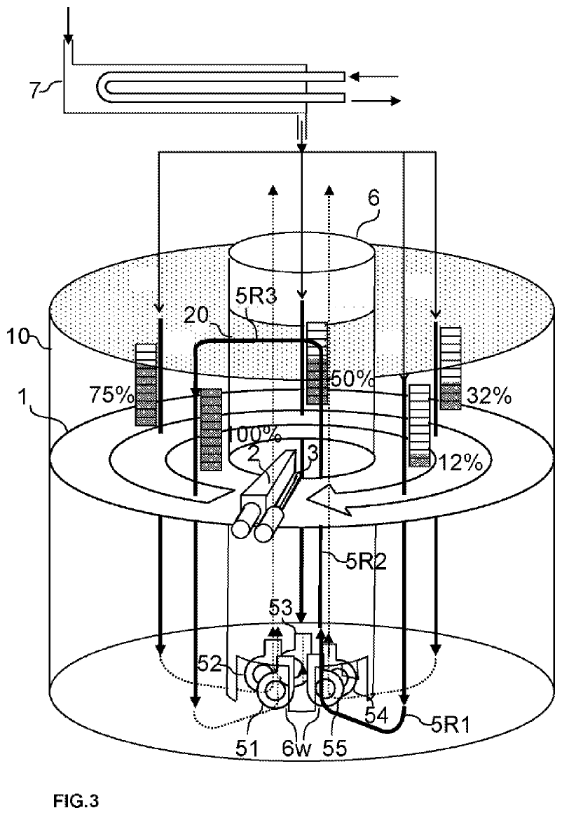

The dryer according to the present invention comprises an enclosure (10) comprising an essentially cylindrical wall extending along a vertical axis (Z). Unlike the dryer described in EP2828595, the enclosure encloses a single circular tray (1) mounted on the wall of the enclosure substantially normal to the vertical axis (Z). The single tray (1) is mounted in rotation in a direction about the vertical axis (Z), and driven in rotation by a first motor. The surface of the tray (1) is perforated by openings having a diameter optimized for the type of particles to be dried, enabling it to retain the particles to be dried while being permeable to fluids such as air, steam and water. Such a dryer is illustrated in FIGS. 2 and 3.

A system (2) for distributing the particles to be dried extends along a radius of the tray (1) and is designed to receive the particles to be dried from a feed unit (9) and to distribute these particles along a radius of the tray (1) before drying. The feed unit controls the loading or feed rate of the particles to be dried onto the tray (1).

A recovery system (3) extends along a second radius of the tray, located downstream of and preferably adjacent to the distribution system (2). The recovery system (3) is designed to recover the particles deposited on the tray (1) after a rotation through a given angle thereof. The angle of rotation is preferably at least 300°, preferably at least 320°, even more preferably at least 340°, and preferably the largest angle that enables the distribution system (2) and the recovery system (3) to be accommodated along the respective radii of the tray (1). A large angle of rotation enables the time that the particles deposited on the tray are exposed to the hot gases to be extended for a given rotation speed. An angle of practically 360° can be obtained by superimposing the distribution system (2) on top of the recovery system (3).

The dryer comprises a hot-gas blowing system comprising N fans (51-5N) designed to generate flows of hot gas along N gas columns that are substantially parallel to the vertical axis (Z). Each gas column passes through a different angular section (1.1-1.N) of the tray (1), with N E N and N>1. It is the hot and dry gas coming into contact with the moist particles that (a) increases the temperature thereof and (b) discharges a part of the moisture thereof. As a result, the temperature of the hot gas drops and the moisture content thereof increases as it passes through the tray (1). The temperature of the hot gas downstream of the tray drops and the moisture content thereof increases as the gradients of temperature and moisture content between the hot gas upstream of the tray and the particles through which the gas is flowing increases. The temperature of the particles increases and the moisture content thereof drops with the angle of rotation of the tray, and therefore in a sequence of the angular sections (1.1 to 1.N). For a constant temperature and moisture content of the hot gas upstream of the tray (1) the temperature of the hot gas downstream of the tray drops and the moisture content thereof increases with the angle of rotation and therefore sequentially from the first angular section (1.1) to the N^{th} angular section (1.N).

The moisture content of the gas in the gas columns coming out of the angular sections (1.1 to 1.(N−1)) of the tray (1) bearing the high-moisture-content particles is too high to be recirculated as it is. It is therefore discharged from the enclosure, as illustrated in FIGS. 2 to 5, or alternatively dehumidified and reheated before being reinjected along the gas columns. Conversely, the particles in the N^{th} angular section (1.N) have, following a rotation in the order of 300°, a high temperature and low moisture content (see for example FIG. 2, 12% moisture). Therefore, having passed through the N^{th} angular section (1.N), the hot gas downstream of the tray has a sufficiently high temperature and a sufficiently low moisture content to not be simply discharged into the atmosphere. The hot-gas blowing system (5) according to the present invention enables the hot gas downstream of the N^{th} angular section (1.N) to be recovered and recirculated in the first angular section (1.1), where the particles have the lowest temperature and the highest moisture content compared to the rest of the tray.

As illustrated in FIG. 2, the N angular sections (1.1-1.N) of the tray cover the whole of an area of the tray between the distribution system (2) and the recovery system (3). In the hot-gas blowing system (5) according to the present invention, a first fan (51) is designed to generate a flow of hot gas along a first gas column parallel to the vertical axis (Z). It is positioned downstream of the distribution system (2) relative to the rotation of the tray, so that the first gas column passes through the first angular section (1.1) of the tray adjacent to or containing the distribution system (2). An N^{th} fan (5N) is designed to generate a flow of hot gas along an N^{th} gas column parallel to the vertical axis (Z). It is positioned upstream of the recovery system. The N^{th} gas column passes through the N^{th} angular section (1.N) of the tray adjacent to or containing the recovery system (3), wherein the terms “upstream” and “downstream” refer to the direction of rotation of the tray. Second to (N−1)^{th} fans (52, 5(N−1)) are distributed angularly about the vertical axis (Z) between the first and the N^{th} fans (51, 5N). They are designed to generate flows of hot gas along second to (N−1)^{th} gas columns parallel to the vertical axis (Z). They pass through second to (N−1)^{th} angular sectors (1.2-1.(N−1)) between the first and N^{th} angular sectors (1.1, 1.N).

Having passed through the first to the (N−1)^{th} angular sections (1.1, N−1) of the tray, the first to the (N−1)^{th} gas columns are either extracted from the enclosure (see FIGS. 2 to 5) or the gas in these columns is dried and reheated before being recirculated by the second to the N^{th} fans (52-5N) to pass through the second to the N^{th} angular sections (1.2, N) of the tray in another cycle, or are discharged from the enclosure, for example via a chimney.

Unlike the first to the (N−1)^{th} gas columns, having passed through the N^{th} angular section (1.N) of the tray, the hot gas of the N^{th} gas column is recirculated by the N^{th} fan (5N) to form, on its own or combined with an additional hot gas, the first gas column passing through the first angular sector (1.1) of the tray.

With this blowing system (5), the dryer according to the present invention provides energy savings when heating the hot gas in the order of (100/N) %, or 20% to 25% energy for a dryer comprising N=5 or 4 fans (51 to 55 or 51 to 54), respectively.

As illustrated in FIG. 2, having passed through the N^{th}=5th angular section (1.5) of the tray, the hot gas of the 5th gas column is recirculated by the first fan (51) to form, on its own or combined with an additional hot gas, the first gas column (1.1) passing through the first angular sector (1.1) of the tray.

If Hi is the moisture content of the particles in each angular section (1.1-1.5) of the tray, it is evident that H1>H2>H3>H4>H5. Similarly, the moisture content of each hot air column corresponding to a section of the tray drops after passing through each angular section of the tray. Consequently, the moisture content contained in the hot gas in the 5th column, having passed through the 5th angular section, is low enough to enable it to be directly recirculated to the first fan in order to dry the particles that are in the first angular section, in which the moisture content H1 of the particles is highest.

Recycling the hot air passing through the N^{th} angular section saves a lot of energy, without adversely affecting efficiency, given the very low moisture content of the hot air that has passed through the N^{th} angular section.

For example, an energy saving has been observed in a hot-air particle dryer with four fans with recirculation of the air from the 4th fan (54) to the first fan (51). The inventors have measured a 25% drop in air flow rate, a 16.5% drop in electrical power drawn, and a 25% drop in heating power compared to the same dryer without recirculation from the 4th fan (54) to the first fan (51).

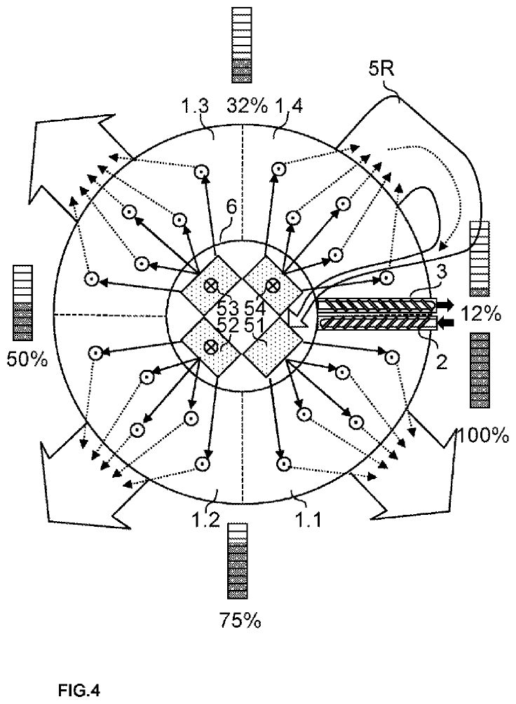

As illustrated in FIGS. 3 and 4, the moisture content of the particles between each angular section of the tray drops during the drying process. For example, the initial moisture content is 100%, the moisture content of the particles is 75% after passing through the first angular section 1.1, the moisture content is 50% after passing through the second angular section 1.2, the moisture content is 32% after passing through the third angular section 1.3, and the moisture content is 12% after passing through the fourth angular section 1.4. The hot air passing through the fourth angular section therefore has a very low moisture content. It can then be recycled and redirected to the first angular section to dry the incoming particles with a high moisture content, for example 100%.

The tray (1) may further comprise a chimney (6) that is centered on the vertical axis (Z) and passes through the tray via a circular opening with an internal radius (R6) less than a radius (R1) of the tray.

The fans are preferably disposed inside the chimney (6) and each comprise a vertical deflection system designed to guide the hot gas generated by each fan into the enclosure and out of the chimney (6) and to orient it substantially parallel to the vertical axis (Z) toward the corresponding angular sectors (1.1-1.N), thereby forming corresponding gas columns. The vertical deflection system preferably comprises at least one of the following: a tube, a deflection surface or a network of deflection surfaces, which is coupled to at least one opening in a wall of the chimney.

In practice, for the N−1 first angular sections of the tray, the gas thus cooled and humidified is then either discharged out of the enclosure into the atmosphere or for another use such as in a heat exchanger (7) or a humidifier (see dotted arrows in FIG. 3 discharging the gases from the dryer upwards through a chimney (6) of the dryer), or recirculated after drying and reheating. The blowing system may comprise one or preferably several fans. The fan or fans may be designed to aspirate the hot gases by creating a depression, for example beneath the trays, when the gas is circulating from the top downwards. In this variant, the fan or fans are positioned beneath the tray (1). Indeed, to limit the pressure drops in the products layer, it may be preferable to aspirate beneath the tray instead of blowing onto the tray. Such an embodiment is illustrated in FIG. 3.

### Blowing—Aspiration

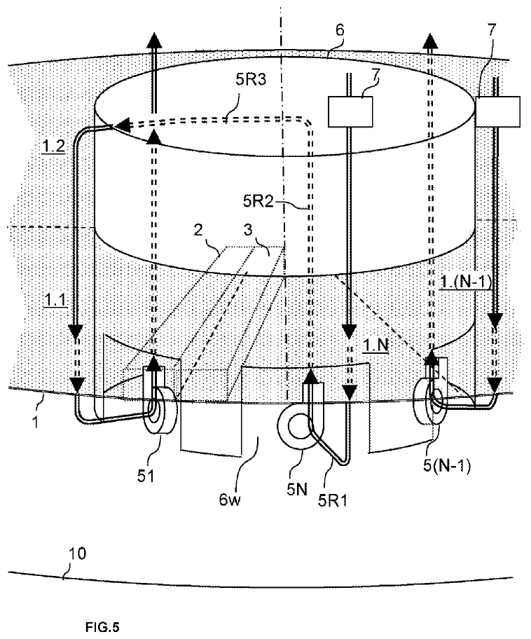

The hot-gas blowing system (5) may therefore be provided either:
by a fan, referred to as a blower, designed to blow the hot gas, preferably hot air, positioned upstream of the tray (1), as illustrated in FIG. 2, or
by a fan, referred to as an aspirator, designed to aspirate the hot gas, preferably hot air, positioned downstream of the tray, as illustrated in FIGS. 3 and 5.

In both cases, the gas is reheated upstream of the tray (1) by a gas heating device (7) positioned upstream of the tray. The gas heating device (7) may be provided by a heat exchanger or a gas burner, or an electric resistor. The terms upstream and downstream here refer to the direction of the flow of hot gas.

The gas heating device (7) (for example air) may be built into an upper level of the dryer positioned above the disc. Cool gas, for example cool air, is thus aspirated from outside above this level. In the case of a “blower” fan, the gas (or air) aspirated by the blower fan is blown toward the tray. The heating device may be positioned anywhere upstream of the tray, for example upstream or downstream of the blower fan, but it is preferably built into the blower fan. In the case of an “aspirator” fan positioned downstream of the tray, the heating device cannot be built into the aspirator fan nor positioned downstream of the aspirator fan. The gas heating device is therefore positioned upstream of the tray. The gas or air is aspirated from the outside, then passes through the gas heating device (7) to reach a temperature of 60 to 95° for example, then passes through the tray before finally entering the aspirator fan to be blown back outside the dryer for the 1^{st} to (N−1)^{th} aspirator fans and toward the first gas column for the N^{th} aspirator fan. The gas blown back by the 1^{st} to the (N−1)^{th} aspirator fans is cooled and practically saturated with moisture, and is discharged for example up the chimney and blown outside.

### Discharge—Recirculation of the Hot Gas

The dryer comprises systems for discharging the hot gas from the (N−1) first gas columns that have passed through the tray. When discharged, the gas is cold and moist. The gas discharge systems are designed to discharge the cool, moist gas from the enclosure. For reasons of comfort in the vicinity of the dryer, the hot gas is preferably discharged upwards, along a vertical column extending from the circular opening. The discharge system may be the chimney, but may also be positioned outside the enclosure, for example about the outer circumference of the enclosure, as illustrated in FIG. 4.

In FIG. 3, having passed through the (N−1)=4 first angular sections (1.1-1.4) of the tray, the gas is discharged through the chimney, with the exception of the hot gas that has passed through the N^{th}=5th angular section, which is redirected toward the first angular section (1.1). In FIG. 4, having passed through the (N−1)=3 first angular sections, the gas is discharged to outside the enclosure.

FIG. 5 is a magnified view of a dryer of the type shown in FIG. 3 showing that the gas that has passed through the N^{th} angular sector (1.N) of the tray (1) is aspirated by the N^{th} fan (5N) (“aspirator” type) and redirected to form the first gas column passing through the first angular sector (1.1) before being aspirated by the first fan (51). The first and N^{th} fans, which in this example operate in aspiration, are positioned beneath the tray and upstream of the recovery system (3) relative to the direction of rotation of the tray. Aspirated by the N^{th} fan (5N), the N^{th} gas column passes through the N^{th} angular sector (1.N) of the tray and is redirected along the trajectory (5R1) through a window (6w) in the chimney where the N^{th} fan (5N) is positioned, said fan blowing the still hot and practically dry gas via a gas deflection system along a trajectory (5R2, 5R3) to form the first gas column, aspirated by the first fan (51). The air thus deflected is aspirated by the first fan (51) to pass through the first angular section (1.1) of the tray before being discharged to outside the enclosure, for example in a tube positioned in the chimney (6).

The deflection system is therefore designed to recirculate the gas from the N^{th} gas column toward the first gas column by guiding it, for example inside the chimney (6) after it has passed through the tray. The gas then circulates toward the inside of the chimney along the trajectory (5R1), goes up the chimney along the trajectory 5R2, and is then redirected toward the first section of the tray along the trajectory (5R3), thereby forming the first hot gas column aspirated by the first fan (51). The recirculation deflection system may for example be provided by a tube, a deflection surface or a network of deflection surfaces, a fan, which is coupled to at least one opening in a wall of the chimney. FIG. 5 shows the recirculation trajectory from the N^{th} column toward the first gas column using “aspirator” fans. It is clear that the same trajectory (5R1, 5R2, 5R3) can be provided with “blower” fans.

As illustrated in FIG. 2, the volume beneath the N^{th} angular section (1.N) of the tray (1) may be provided with walls (10d) separating it from the volumes beneath the (N−1)^{th} angular section (1.(N−1)) and/or in particular beneath the first angular section (1.1) to prevent recirculation of the hot gas from other gas columns.

The system may comprise a controller (8) designed to control one or more of the following parameters:
a gas flow rate from one or more of the N fans,
a proportion of the first gas column that is gas recycled from the N^{th} column toward the first fan (51),
a geometry of the vertical deflection system that modifies an extent of each angular sector (1.1-1.N) and a degree of overlap between two adjacent angular sectors.

The system may further comprise a temperature sensor and a moisture sensor designed to measure the temperature and the moisture content of the hot gas coming out of the N^{th} angular section (5N) before being recirculated toward the first gas column. The controller is designed to determine the proportion of the first gas column that is gas recycled from the N^{th} column toward the first fan (51) on the basis of the temperature and moisture content values measured by the temperature and moisture sensors. If the temperature of the gas coming from the N^{th} gas column is too low or the moisture content thereof is too high to adequately heat and dry the particles deposited in the first angular section (1.1) of the tray, it should be mixed with hot, dry gas. However, if the temperature of the hot gas is too low or the moisture content is too high, it is probable that the particles in the N^{th} angular section of the tray passed through by the N^{th} gas column have a temperature that is too low and/or a moisture content that is too high. The drying parameters must therefore potentially be modified accordingly.

The hot gas (for example hot air) can circulate from the bottom upwards. As the flow of hot gas circulates from the bottom upwards, the particles may be blown away and create a dust cloud. A slight fluidization of the particle layer may be advantageous for the drying thereof, but the formation of a cloud of fine dust in suspension in the air must be avoided. This arrangement is therefore better for drying heavier particles that do not easily form a dust cloud.

For particles that are more lightweight or finer, the hot gas can preferably circulate from the top downwards, as shown in FIGS. 1 to 6. In this arrangement, the particles are pressed against the tray they are on, which considerably reduces suspended dust. A flow of hot gas from the top downwards risks forming compact clusters of particles compressed together that are difficult to dry. These compact clusters are however broken up during recovery of the particles from the tray (1) by the recovery system.

### Structure of the Dryer—Feed Unit (9)

The feed unit (9) is coupled upstream to a particle source (20s), for example particles stored in a silo, a container, a bin, etc. The feed unit (9) is coupled downstream to the distribution system (2). The feed unit (9) preferably precisely controls and varies the particle feed rate to the distribution system (2) to control the thickness (da) of the layer of particles deposited on the tray by the distribution system (2).

Any feed unit enabling such control known to the person skilled in the art can be used and the present invention is not limited to a particular type or model of feed unit. For example, the feed unit (9) may comprise one or more Archimedes screws, the rotation speed of which controls the feed rate of the coarse particles feeding the distribution system (2). Alternatively, the feed unit may comprise a conveyor belt, the movement speed of which can be controlled to control the feed rate.

### Structure of the Dryer—Distribution System (2)

The feed unit (9) is coupled downstream to the distribution system (2) and is designed to feed the distribution system (2) at a controlled feed rate. The system (2) for the distributing particles to be dried on the tray (1) is intended to distribute the particles to be dried uniformly along a radius of the tray (1). In general, the distribution system (2) comprises:
a structure extending from the outer periphery to the inner periphery of a tray, preferably along a radius thereof,
means for conveying particles from the outer periphery to the inner periphery of the trays, and finally
means for depositing said particles from the conveyance means to the trays.

Several solutions are possible. For example, particles can be conveyed from the outer periphery to the inner periphery of the trays by a conveyor belt, which may be perforated or inclined transversely to enable the particles to sprinkle the tray positioned below. To help with sprinkling, the belt may be vibrated. In an alternative preferred variant, the distribution system (2) comprises at least one Archimedes screw extending along a radius of the tray (1) to convey the particles from the outer periphery to the inner periphery of the tray (1). Said at least one Archimedes screw is enclosed in an enclosure provided with one or more openings extending downwards and along said radius of the tray (1) to enable the particles to be sprinkled uniformly along the radius of the tray (1).

In the case of an Archimedes screw, if the particles to be dried are discharged by the feed unit (9) at a first end of the Archimedes screw of the distribution system (2), for example adjacent to the enclosure (10), there is a significant risk of the thickness of the layer of particles getting smaller along the radius of the tray (1) nearer to the center of the tray. Such a thickness gradient is not advisable since that results in a gradient along the radius of the tray (1) of intermediate levels of moisture content (H1a) of the particles after a rotation on the tray (1). Worse still, if the layer becomes so thin that holes appear in the particle layer, this creates zones of low resistance to the flow of hot gas, which will then pass preferably through these zones to the detriment of the particles to be dried.

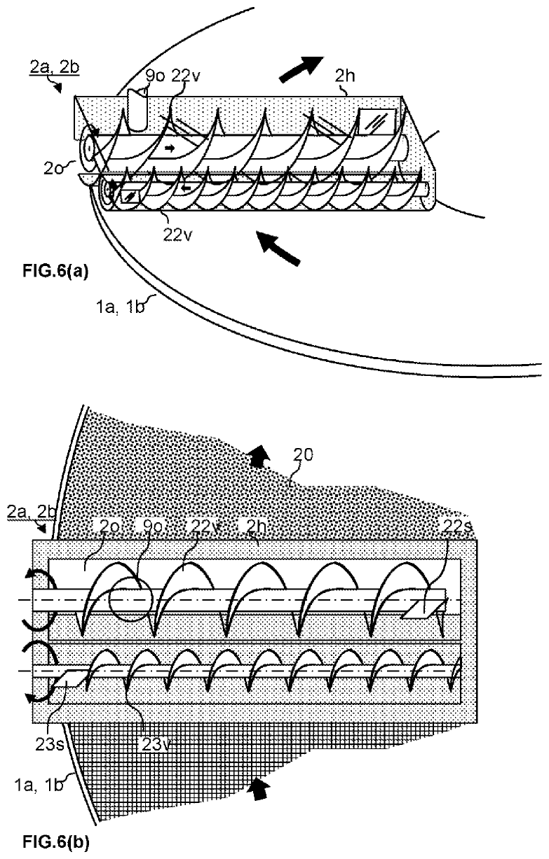

To overcome this problem, the distribution system (2) extending along a radius of the tray (1) may comprise, as illustrated in FIGS. 6(a) and 6(b), a distribution screw (22v) and a recirculation screw (23v) arranged side-by-side and enclosed in a housing (2h). The housing (2h) comprises a feed opening coupled to an output (90) of the feed unit (9). The feed opening is designed to deliver particles coming from the feed unit (9) to one end of the distribution screw (22v). For example, the feed opening may be positioned above the distribution screw (22v) to enable the particles to fall by gravity into the housing (2h) and to be carried by the rotation in a first direction of the distribution screw (22v) along the radius of the tray (1).

A distribution opening (20) extends along the length of a lower face of the housing (2h), beneath the distribution screw (22v) to enable the particles to leave the housing (2h) by gravity and to fall onto the tray (1) along the radius thereof. To prevent the majority of the particles falling in a section adjacent to the feed opening (90), the distribution screw (22v) is only partially separated from the recirculation screw (23v), enabling a surplus of particles to pass from the distribution screw (22v) to the recirculation screw (23v), which rotates in a second direction opposite to the first direction of rotation of the distribution screw (22v) to convey the particles thus transferred toward the enclosure (10) (i.e. toward the outer ends of the distribution and recirculation screws (22v, 23v)). At the outer end of the recirculation screw (23v) adjacent to the enclosure, the recirculation screw (23v) is provided with a blade (23s) that, by rotation of the recirculation screw (23v), conveys the particles toward the distribution screw (22v). A similar blade (22s) is arranged at the end of the distribution screw (22v) at the inner end of the distribution screw (22v) close to the center of the dryer in order to transfer the particles at this end toward the recirculation screw (23v), without falling on the tray (1) through the distribution opening (20). A distribution system (2) of this type enables a uniform distribution of the particles along the radius of the tray (1), thereby ensuring that the thickness of the layer of particles deposited on the tray (1) is radially substantially constant.

The system (2) for distributing the particles to be dried on the tray (1) is connected upstream, preferably by means of a feed unit (9), to a source (20s) of particles to be dried, preferably a silo. The particles preferably comprise wood waste from sawmills, wood waste from construction materials, paper or cardboard waste, agri-food products such as cereals, and are in the form of powder, granules, chips, pellets, meals, or pieces not usually greater than 10 cm long.

### Structure of the Dryer—Recovery System (3)

The recovery system (3) of the tray (1) recovers the particles deposited on the tray (1) after a rotation thereof. The recovery system (3) is therefore positioned upstream of the distribution system (relative to the direction of rotation of the tray) and adjacent thereto so that the particles having an initial moisture content (H1) deposited on the first section (1.1) of the tray by the distribution system can make one rotation, preferably between 34° and 360°, or preferably between 345 and 355°, before being collected from the N^{th} angular section (1.N) and discharged from the tray (1) with a final moisture content (HN) by the recovery system (3). To maximize the angle of rotation of the particles on the tray (1) between the distribution system (2) and the recovery system (3), they are preferably arranged next to one another, or else the distribution system (2) can be arranged above the recovery system (3).

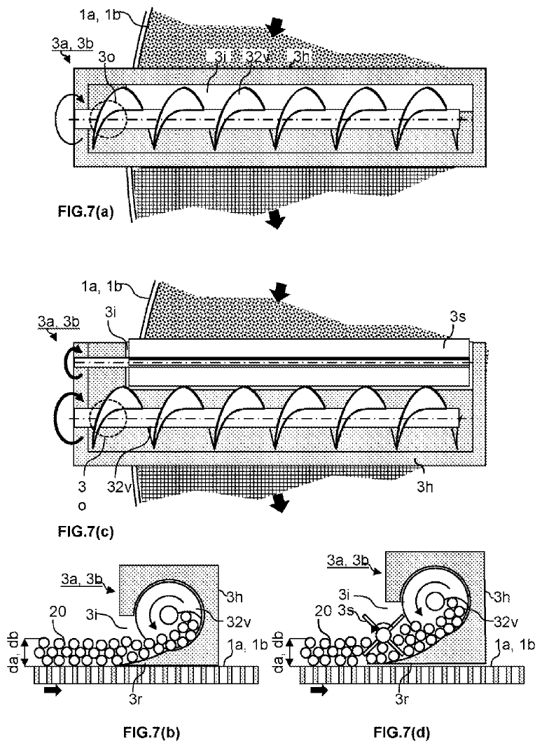

As illustrated in FIGS. 7(a) and 7(c), the recovery system (3) preferably comprises at least one Archimedes screw (32v) extending along a radius of the tray that is enclosed in a housing (3h) provided with one or more recovery openings (3i) extending along said radius of the tray. The openings are connected to a scraper (3r) or brush designed to collect and guide the particles conveyed by the rotation of the tray (1) through the recovery opening (3i) in the housing (3h) of the Archimedes screw (32v). By turning, the Archimedes screw conveys the particles thus collected to a discharge opening (30) that is connected to a discharge unit (40) that is designed to discharge the dried particles from the enclosure (10) to a location for storage or subsequent processing. If for a given application the particles have a moisture content (HN) that is too high after one rotation of the tray:
the thickness of the layer of particles deposited on the tray may be reduced, and/or
the rotation speed of the tray may be reduced, and/or
the discharge unit (40) may be connected to the feed unit (9) to return the particles to the tray using the distribution system (2) for a second rotation.

FIGS. 7(b) and 7(d) illustrate another variant of the recovery system (3) that is particularly but not exclusively suited to cases in which the tray (1) has a raised circumferential edge requiring the Archimedes screw (32v) to be raised above this edge. As in the variant in FIGS. 7(a) and 7(c), in the present variant, the recovery system (3) comprises an Archimedes screw (32v) that is rotated to radially convey the collected particles along a radius of the tray (1) to the outside thereof and to discharge them toward the discharge opening (30) connected to the discharge unit (40). In the present variant, the recovery system (3) further comprises a multi-blade mill (3s) disposed upstream of and parallel to the Archimedes screw (32v). The rotation of the multi-blade mill (3s) enables the Archimedes screw (32v) to be fed even if it is raised in relation to the surface of the tray. In any case, the multi-blade mill (3s) provides a reproducible and reliable particle feed to the Archimedes screw (32v).

### Tray (1)

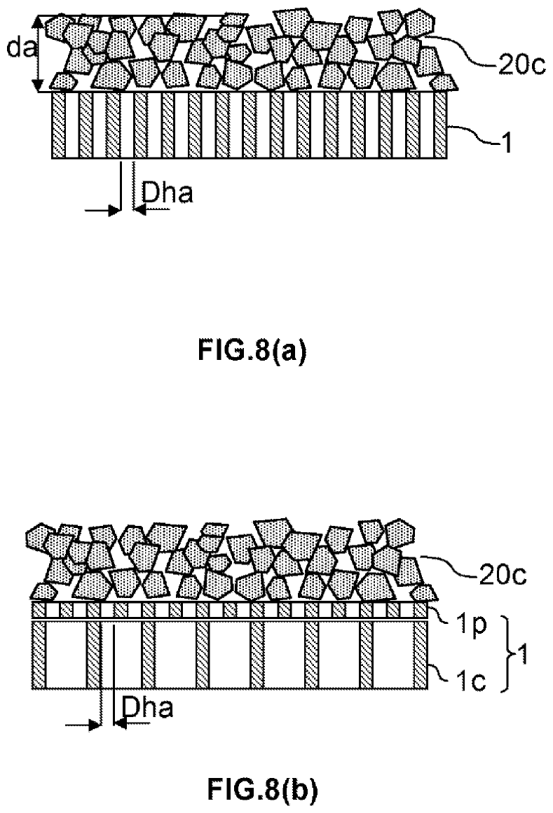

The dryer according to the present invention is particularly advantageous because it can be used to dry particles of very different sizes, from fine particles such as sawdust, fine grains, and ceramic, polymer or metal powders, to coarser particles such as wood waste, chips, pellets, agricultural waste, corn husks, etc. In a first variant illustrated in FIG. 8(a), the tray is self-supporting and comprises openings of a given diameter. To facilitate the rapid and easy changing of the diameter of the orifices in the tray, in a second variant illustrated in FIG. 8(b), the tray (1) may thus comprise a highly permeable, rigid, self-supporting grating structure (1c). In FIG. 8(b), a filtering layer (1p) comprising openings of size and density corresponding to the desired permeability depending on the type and size of the particles to be dried is placed on the highly permeable self-supporting structure 1c. The filtering layer (1p) maybe a perforated metal sheet, a screen, a grill or a canvas that may be easily changed depending on the type of particles to be dried. To facilitate the installation of such a filtering layer, it may be cut into angular sectors that can be positioned and fastened side-by-side directly on the grating or another highly permeable, self-supporting structure (1c). This would not be possible in practice with belt dryers or perforated tray dryers, which are used to dry particles of a single size.

The tray (1) is enclosed in an external enclosure of diameter corresponding to the diameter of the tray with sufficient margin to prevent friction, but also as little as possible to enable the interface between the trays and the outer wall to be sealed. The seal may for example be provided by a flexible skirt fastened to the outer wall and resting on a raised edge of the circumference of the trays. This means that the layer of particles resting on a tray in rotation is not in contact with the static skirt, thus ensuring a good seal and protecting the layer of particles on the tray. This would not be possible with a belt dryer, where the sealing skirt is positioned between the conveyor belt and the particles on the edges of the belt. There is therefore a fringe of particles in contact with the static skirt on each side of the belt that does not move at the same speed as the particles in the middle of the belt.

As illustrated in FIG. 3, the central part of the tray is preferably hollow and included in a chimney (6) that is cylindrical, internal and centered on the axis of rotation (Z). Such a chimney (6) extending over practically the entire height of the dryer brings numerous advantages that comfortably offset the loss of surface area available for drying. Indeed, if the external diameter of the trays is D1 and the diameter of the cylindrical chimney is D6=n×D1, where n<1, the loss of surface area (A) available on the tray for drying between a full tray and a tray comprising a chimney is A6/A1=n2. For example, if the diameter of the chimney is one third of the outer enclosure (i.e. n=⅓), the loss of surface area available for drying is only n2= 1/9˜11%. A chimney (6) firstly provides operators with easy access to all of the mechanical elements of the machine, such as bearings, gear motors, cylinders, etc. It also facilitates replacement of the flexible porous layers (1p) to be positioned and fastened on the gratings (1c), giving the trays mechanical integrity. The chimney can also be used to seat the motors driving the rotation of the trays, as well as the fans used to generate the flow of hot gas, with the advantage of a substantial reduction in unwanted noise generated by the dryer. In the case of a gas flow from the top downwards, as shown in FIG. 3, windows at the bottom of the chimney (6), positioned beneath the lower tray, enable the hot gas to be recovered and discharged from the top inside the enclosure. Alternatively, the hot gases may be discharged via a space defined in a double wall of the enclosure (10).

Furthermore, the chimney (6) enables the distribution system (2) and the recovery system (3) to be fastened at the two ends thereof, thereby obviating the need to fasten them projecting from the outer enclosure only. This also frees up space at the inner ends of said means positioned side-by-side to accommodate the width thereof. Finally, such a structure helps to stiffen the surface between the chimney (6) and the outer enclosure (10), helping to keep the tray flat. This is important for cleaning and recovering particles using a scraper or a brush, which are only effective if the surface of the trays is perfectly flat.

Since the distribution of the size of the particles of a given type may be broad, it is difficult to prevent the finest fraction of the particles from passing through the perforations in the tray and falling onto the lower tray or trays, then onto the floor of the enclosure enclosing the tray.

Fine particles may nonetheless fall onto the floor of the dryer. In order to prevent particles accumulating on the floor and also to recover said particles, it is advantageous to provide the floor with an opening for extracting the finest particles deposited on the floor. Furthermore, a scraper or brush rigidly connected to the lower tray and designed to follow the rotational movement thereof pushes the particles deposited on the floor toward said discharge opening. Since the scraper or brush is fastened to the lower tray, there is no need for it to be individually driven.

| Reference # | Feature |
|---|---|
| 1 | Tray |
| 1.i | Angular section i |
| 1c | Highly permeable, rigid, self-supporting structure of |
| | the tray (for example, grating) |
| 1p | Filtering layer of the tray |
| 2 | Distribution system |
| 2h | Housing of the distribution system |
| 2o | Distribution opening |
| 3 | Recovery system |
| 3h | Housing of the recovery system |
| 3i | Recovery opening of the recovery system |
| 3o | Discharge opening of the recovery system |
| 5 | Hot-gas blowing system |
| 5g | Hot gas |
| 5i | Fan |
| 5R(i) | Trajectory of redirected (recycled) gas |
| 6 | Chimney |
| 6w | Opening |
| 7 | Gas heating device |
| 9 | Unit for feeding particles to the distribution system |
| 9o | Feed opening |
| 10 | Enclosure |
| 10d | Wall |
| 20 | Particles |
| 20s | Source of particles to be dried |
| 22v | Distribution screw of the distribution system |
| 22s | Blade |
| 23v | Recirculation screw of the distribution system |
| 32v | Archimedes screw of the recovery system |
| da | Thickness of the particle layer |
| H0a | Initial moisture content before drying during distribution |
| | on the 1^{st} tray |
| H0b | Intermediate moisture content during distribution on the |
| | 2^{nd} tray (H1a = H0b) |
| H1a | Intermediate moisture content during recovery from the |
| | 1^{st} tray (H1a = H0b) |
| H1b | Final moisture content during recovery from the 2^{nd} tray |

1. A dryer for drying particles comprising:
(a) an enclosure (10) comprising an essentially cylindrical wall extending along a vertical axis (Z),
(b) a single tray (1) that is circular and mounted in the enclosure, substantially normal to the vertical axis (Z), in rotation in a direction of rotation about the vertical axis (Z), the surface of the tray being perforated and permeable to gases such as air and steam and water,
(c) a distribution system (2) that is designed to distribute the particles before drying along a radius of the tray (1),
(d) a recovery system (3) that is designed to collect the particles deposited on the tray (1) after a rotation of the tray through an angle formed between the distribution system (2) and the recovery system (3), the recovery system being located downstream of the distribution system (2),
(e) a hot-gas blowing system (5) comprising at least one of N fans (51-5N) designed to generate flows of hot gas along N gas columns that are substantially parallel to the vertical axis (Z), each gas column passing through a different angular section (1.1-1.N) of the tray (1), with N∈N and N>1, wherein
the N angular sections (1.1-1.N) of the tray cover the whole of an area of the tray between the distribution system (2) and the recovery system (3),
a first fan (51) designed to generate a flow of hot gas along a first gas column is positioned downstream of the distribution system (2), the first gas column passing through a first angular section (1.1) of the tray adjacent to or containing the distribution system (2),
an N^{th} fan (5N) designed to generate a flow of hot gas along an N^{th} gas column is positioned upstream of the recovery system, the N^{th} gas column passing through an N^{th} angular section (1.N) of the tray adjacent to or containing the recovery system (3), wherein the terms “upstream” and “downstream” refer to the direction of rotation of the tray, and
second to (N−1)^{th} fans (52, 5(N−1)) are distributed angularly about the vertical axis (Z) between the first and N^{th} fans (51, 5N), which are designed to generate flows of hot gas along second to (N−1)^{th} gas columns passing through second to (N−1)^{th} angular sectors (1.2-1.(N−1)) between the first and N^{th} angular sectors (1.1, 1.N),
having passed through the first to the (N−1)^{th} angular sections (1.1, 1.N−1) of the tray, the first to the (N−1)^{th} gas columns are either extracted from the enclosure or the gas in these columns is dried and reheated before being recirculated by the second to the N^{th} fans (52-5N) to pass through the second to the N^{th} angular sections (1.2, N) of the tray in another cycle,
characterized in that having passed through the N^{th} angular section (1.N) of the tray, the hot gas of the N^{th} gas column is recirculated to form, on its own or combined with an additional hot gas, the first gas column passing through the first angular sector (1.1) of the tray.

2. The dryer as claimed in claim 1, wherein the tray (1) comprises a chimney (6) that is centered on the vertical axis (Z) and passes through the tray via a circular opening with an internal radius less than a radius of the tray.

3. The dryer as claimed in claim 2, wherein the fans are disposed inside the chimney (6) and are each associated with a vertical deflection system designed to guide the hot gas generated by each fan into the enclosure and out of the chimney (6) and to orient it substantially parallel to the vertical axis (Z) toward the corresponding angular sectors (1.1-1.N), thereby forming corresponding gas columns, which is coupled to at least one opening (6w) in a wall of the chimney.

4. The dryer as claimed in claim 2, comprising a recirculation deflection system designed to recirculate the gas from the N^{th} column toward the first fan (51) by guiding it toward the inside of the chimney (6), and wherein the recirculation deflection system which is coupled to at least one opening in a wall of the chimney.

5. The dryer as claimed in claim 1, also comprising a controller designed to control one or more of the following parameters:
a gas flow rate from one or more of the N fans,
a proportion of the first gas column that is gas recycled from the N^{th} column toward the first fan (51),
a geometry of the vertical deflection system that modifies an extent of each angular sector (1.1-1.N) and a degree of overlap between two adjacent angular sectors.

6. The dryer (1) as claimed in claim 5, comprising a temperature sensor and a moisture sensor designed to measure the temperature and the moisture content of the hot gas coming out of the N^{th} angular section (5N) before being recirculated toward the first gas column, and wherein the controller is designed to determine the proportion of the first gas column that is gas recycled from the N^{th} column toward the first fan (51) on the basis of the temperature and moisture content values measured by the temperature and moisture sensors.

7. The dryer as claimed in claim 1, wherein the hot-gas blowing system (5) comprises:
a fan, located upstream of the tray (1) and designed to blow the hot gas, and
a gas heating device designed to heat the hot gas thus blown upstream of the first tray (1),
where the term “upstream” refers to the direction of the flow of hot gas.

8. The dryer as claimed in claim 1, wherein the hot-gas blowing system (5) comprises:
a fan,
a gas heating device designed to heat the hot gas thus aspirated, located upstream of the first tray (1), wherein the gas heating device comprises at least one of the following: a heat exchanger or a gas burner.
where the terms “upstream” and “downstream” refer to the direction of the flow of hot gas.

9. The dryer as claimed in claim 1, wherein the hot gas circulates from the top downwards.

10. The dryer (1) as claimed in claim 1, wherein the hot gas circulates from the bottom upwards.

11. The dryer as claimed in claim 1, wherein the tray (1) comprises a highly permeable, rigid, self-supporting grating structure, on which is placed a filtering layer comprising openings of size and density corresponding to the desired permeability depending on the type and size of particles to be dried.

12. The dryer as claimed in claim 1, wherein the system (2) for distributing the particles to be dried on the tray (1) comprises at least one Archimedes screw extending along a radius of the tray (1), said at least one Archimedes screw being enclosed in an enclosure provided with one or more openings extending along said radius of the tray (1).

13. The dryer as claimed in claim 1, wherein the recovery system (3) of the tray (1) comprises at least one Archimedes screw extending along a radius of said tray that is enclosed in an enclosure provided with one or more openings extending along said radius of the tray (1), said openings being connected to a scraper or brush designed to collect and guide the particles conveyed by the rotation of the tray toward the Archimedes screw.

14. The dryer as claimed in claim 1, comprising a static floor located beneath the tray (1) along the vertical axis Z, the floor comprising an opening for discharging the finest particles deposited on the floor, said dryer further comprising a scraper rigidly connected to the tray and designed to follow the rotational movement thereof to push the particles deposited on the floor toward said discharge opening.

15. The dryer as claimed in claim 1, wherein the particles to be dried are at least one of wood waste from sawmills, wood waste from construction materials, paper or cardboard waste, agri-food products, and are in the form of powder, granules, chips, pellets, meals, or pieces not greater than 10 cm long.

16. The dryer as claimed in claim 1, wherein the recovery system is adjacent to the distribution system (2).

17. The dryer as claimed in claim 3, wherein the vertical deflection system comprises at least one of: a tube, a deflection surface or a network of deflection surfaces.

18. The dryer as claimed in claim 4, wherein the recirculation deflection system comprises one or more of: a tube, a deflection surface or a network of deflection surfaces, and a fan.

19. The dryer as claimed in claim 1, wherein the hot gas is hot air.
